(19) United States
(12) Patent Application Publication
(10) Pub. No.: US 2014/0221881 A1
(43) Pub. Date: Aug. 7, 2014

(54) DEVICE FOR REPETITIVE SPINE EXTENSION AT SELECTABLE LUMBAR LEVELS FOR STIMULATION OF VERTEBRAL SEGMENTS

(71) Applicant: BETTER BACK TECHNOLOGIES, LLC, Las Vegas, NV (US)

(72) Inventors: Allyn D. Schlauder, Las Vegas, NV (US); Michael V. Halliday, Salem, UT (US)

(73) Assignee: Better Back Technologies, LLC, Las Vegas, NV (US)

(21) Appl. No.: 13/760,484

(22) Filed: Feb. 6, 2013

(51) Int. Cl. A61H 99/00

(52) U.S. Cl. CPC A61H 99/00
USPC 601/23

(57) ABSTRACT

Devices and related methods of use for providing repetitive spinal extension exercise. The device includes a frame extending between a foot end and a head end, a footrest member at the foot end of the frame, and a horizontal seat member between the foot end and the head end of the frame. A height-adjustable back pad fulcrum is attached to the frame between the seat member and a pivoting post is attached to the head end of the frame. The pivoting post is positioned behind the back pad fulcrum, and may be biased to default to an acute angle relative to the seat member. The pivoting post may include a back roller or pad attached thereto (e.g., near a top end thereof) so that a user seated on the seat member may press the roller and pivoting post backwards as the user rearwardly extends an upper portion of the torso.

### BACKGROUND OF THE INVENTION

1. The Field of the Invention

The present invention is in the field of therapeutic devices for use in relieving back pain, and in strengthening and conditioning the muscles surrounding the spine.

2. The Relevant Technology

A significant fraction of the population experiences back pain, which may be attributable to various causes. There continues to exist a need for devices and methods which may be employed in the relief of such pain, and for use in strengthening and conditioning muscles, joints, and other body structures of the back and surrounding area.

### BRIEF SUMMARY

The present invention is directed to therapeutic devices and associated methods of use for providing repetitive spinal extension at selectable lumbar levels. The inventors have found that such movement by the user results in cyclic loading and unloading of the vertebral segments, which can provide hydration and stimulation to the vertebral segments. In addition to strengthening and conditioning the para-spinal muscles surrounding the spine, the inventors have found that such exercise movements can relieve back pain, sciatic pain, and leg pain, and can, for at least some users, result in disc regeneration within the user's vertebrae.

According to one embodiment, the device may include a frame extending between a foot end and a head end, a foot rest member attached to the foot end of the frame, a horizontal seat member attached to the frame between the foot end and the head end of the frame, and a back pad fulcrum attached to the frame between the seat member and the pivoting post, the back pad fulcrum being adjustable in height above the seat member to allow progressive repetitive spinal extension at varied lumbar levels. The device further includes a pivoting post attached to the head end of the frame, positioned behind the back pad fulcrum. The pivoting post may include a back roller or back pad attached near a top end of the pivoting post so that a user seated on the seat member may press the roller and pivoting post backwards as the user rearwardly extends an upper portion of his or her torso while the lower portion of the back is pressed against the back pad fulcrum.

The pivoting post may be biased to default to a “forward” position forming an acute angle relative to the seat member. The device may further include one or more cams (e.g., one on either side of the pivoting post) about which one or more resistance members (e.g., elastomeric members, springs, etc.) extend. One end of each resistance member may be attached to the corresponding cam while the other end of each resistance member may be attached to the frame at a location below the bottom of the pivoting post so that the cam(s) pivot with the pivoting post, providing resistance as the post is pivoted backwards as the user's back above the back pad fulcrum presses on the roller.

The frame may include a generally vertical pivoting post support member and a generally vertical back pad fulcrum support member that is parallel to and in front of the pivoting post support member so that when the pivoting post is vertical it defines a vertical axis that is behind a generally vertical axis of the back pad fulcrum support member. Positioning of the pivot point of the pivoting post behind the back pad fulcrum and well behind an axis of the user's hips causes the roller to move up and down the user's back and/or neck during use, creating a massaging action that encourages continued use.

Another embodiment of the device may include a frame extending between a foot end and a head end, a foot rest member attached to the foot end of the frame, a horizontal seat member attached to the frame between the foot end and the head end of the frame, and a back pad fulcrum attached to the frame between the seat member and the pivoting post, the back pad fulcrum being adjustable in height above the seat member to allow progressive repetitive spinal extension at varied lumbar levels. The device may further include a pivoting post attached to the head end of the frame, positioned behind the back pad fulcrum. The pivoting post may include a back roller or sliding back pad attached near a top end of the pivoting post so that a user seated on the seat member may press the roller and pivoting post backwards as the user rearwardly extends an upper portion of his or her torso while the lower portion of the back is pressed against the back pad fulcrum. The pivoting post may be biased to default to a “forward” position, forming an acute angle relative to the seat member. The device may further include a pair of cams on either immediate side of the pivoting post about which one or more elastomeric resistance members extend. One end of each resistance member may be attached to a corresponding cam so that the resistance member extends over a curved surface of each cam running generally along a longitudinal length of the respective cam. The other end of each resistance member may be attached to the frame at a location below the pivoting post so that the cams pivot with the pivoting post, providing resistance as the post is pivoted backwards as the user's back above the back pad fulcrum presses on the roller.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary device according to an embodiment of the present invention;

FIG. 1B is a close-up perspective view of the cam structures of the device of FIG. 1A;

FIG. 1C is a close-up perspective view of the cam structures of FIG. 1B from another perspective;

FIG. 1D is a close-up perspective view of a configuration similar to that seen in FIGS. 1B-1C, but including a tensioning knob for adjusting the tension provided by the elastomeric resistance members without requiring the user to engage or disengage resistance members;

FIG. 2A is a side view of the device of FIG. 1A in which a user is seated on the seat member and the user's back is positioned against the roller attached to the pivot post in preparation for exercise;

FIG. 2B is a side view of the device and user of FIG. 2A in which the user has pivoted his torso forward, the user's back remaining in contact with the roller attached to the pivot post;

FIG. 2C is a side view of the device and user of FIG. 2B in which the user has pivoted his torso backward so that the pivot post is generally vertical or somewhat past vertical;

FIG. 3 is a side view of the device and user of FIG. 2C in which the back pad fulcrum has been moved up relative to the position shown in FIGS. 2A-2C so that the user may repeat the exercise with the back pad fulcrum at a higher lumbar level to isolate the general movement to that portion of the user's back that is above the back pad fulcrum; and

FIGS. 4-10 show a perspective view, a front view, a back view, a side view, an opposing side view, a top view, and a bottom view, respectively, of an ornamental design of a therapeutic device for repetitive spinal extension according to the present invention.

### DETAILED DESCRIPTION OF THE PREFERRED EMBODIMENTS

I. Introduction

The present invention is directed to therapeutic devices and related methods of use for providing repetitive spinal extension exercise, which can relieve back pain and related pain, while also providing strengthening and conditioning of the para-spinal muscles. According to one such embodiment, the device includes a frame extending between a foot end and a head end, a footrest member attached to the foot end of the frame, and a horizontal seat member attached to the frame between the foot end and the head end of the frame. The device further comprises a back pad fulcrum attached to the frame between the seat member and a pivoting post attached to the head end of the frame. The back pad fulcrum may be adjustable in height above the seat member to allow progressive repetitive spinal extension exercises at varied lumbar levels. The pivoting post is positioned behind the back pad fulcrum (i.e., towards the head end of the frame). The pivoting post may be biased to default to an acute angle relative to the horizontal seat member. The pivoting post may include a back roller or pad attached thereto (e.g., near a top end thereof) so that a user seated on the seat member may press the roller and pivot post backwards as the user rearwardly extends an upper portion of the torso. The lower portion of the back of the user is pressed firmly against the back pad fulcrum, so that the portion of the back above the back pad is generally the portion of the user's back performing the alternating forward/rearward bending movement (or at least the rearward movement).

The device includes at least one cam on at least one side of the pivoting post. Preferably, dual cams are provided on both sides of the pivoting post. One or more resistance members (e.g., elastomeric members, springs, etc.) extend over the cam(s), with one end of the resistance members connected to the cam and the other end attached to the frame (e.g., at a location below the pivoting post) so that the cam(s) pivot with the pivoting post and provide resistance as the post is pivoted backwards as the user's back presses the pivotable post backwards.

The frame may include a generally vertical pivoting post support member to which the pivoting post may be attached, and a generally vertical back pad fulcrum support member to which the back pad fulcrum may be attached. The generally vertical pivoting post support member and back pad fulcrum support member may be aligned with one another. For example, the support members may be parallel to and spaced apart from one another in the same central longitudinal plane at a center of the device, with the pivot post support member behind and aligned with the back pad fulcrum support member.

The terms “behind”, “in front”, “right”, “left” and similar terms as used herein are typically with reference to a user seated on the seat member (e.g., and oriented with the user's feet on the foot rest member(s) and back against the back pad fulcrum). Thus, the head end of the frame and device may generally be “behind” the seated user, and the foot end of the frame and device may generally be “in front of” or “forward” relative to the seated user.

The inventors have found that repetitive exercise movements facilitated through use of the device can provide surprisingly effective relief of back pain, sciatic pain, and similar pain associated with back problems. The device is particularly suited to facilitate relatively low resistance, high frequency, high repetition exercises with minimal risk of injury through its use. As such, the device and its use are particularly suited for home use and other “unsupervised” use, although of course use may also be provided in a clinical setting, where supervision may be provided. Of course, some basic instruction provided by a clinician prior to first use may be helpful in aiding a user in achieving maximal benefit from the device, although once a user is accustomed to its use, little or no supervision may be needed, allowing a user to use the device relatively frequently, and with relatively high numbers of repetitions with little or no risk of injury as may tend to exist with other devices and exercises in which fixation of the user (e.g., the user's hips and/or legs, etc.) or associated forceful protocols are employed.

For example, the device preferably does not employ Velcro straps, pads, pneumatic compression or other fixation means for firmly fixating the user's hips and/or legs (e.g., much like a vice) in an attempt to isolate exercise movement to all or a part of the vertebral column. Such an approach may require that a patient's bones, muscles and joints be sufficiently healthy and strong to tolerate such concentrated forces. This may be particularly troublesome where isolation is applied to the upper regions of the vertebral column where the anatomical structures are significantly smaller and more vulnerable. As a result, there may be an increased risk of injury, so that guidelines of use for such devices and exercises may provide for only a few repetitions, ideally performed only twice a week, for example. One such device is the PneuBack Chair, available from Pneumex, and described in U.S. Pat. No. 6,672,998. The present inventive device and exercises are not so configured, but are configured to provide for significantly higher repetitions and significantly higher frequency of use in which the body is not rigidly fixed, and where risk of injury is minimal.

For example, the stabilization strategy employed with the present inventive device and exercise methods is comparatively mild, achieved through use of the user's own body weight upon the seat (without any “seat belts” or other fixation), with the feet placed on the foot rest member(s) and the lumbar portion of the spine placed against the back pad fulcrum. Use of the device is thus intended to be gentle and intuitive, allowing the user to voluntarily move the height-adjustable back pad fulcrum up and down the lumbar spine for repetitive use at varied lumbar levels. The process is configured to smoothly and cyclically load all vertebral and thoracic joints while it simultaneously strengthens all muscles that participate in axial extension (i.e., upright posture).

II. Exemplary Devices and Methods of Use

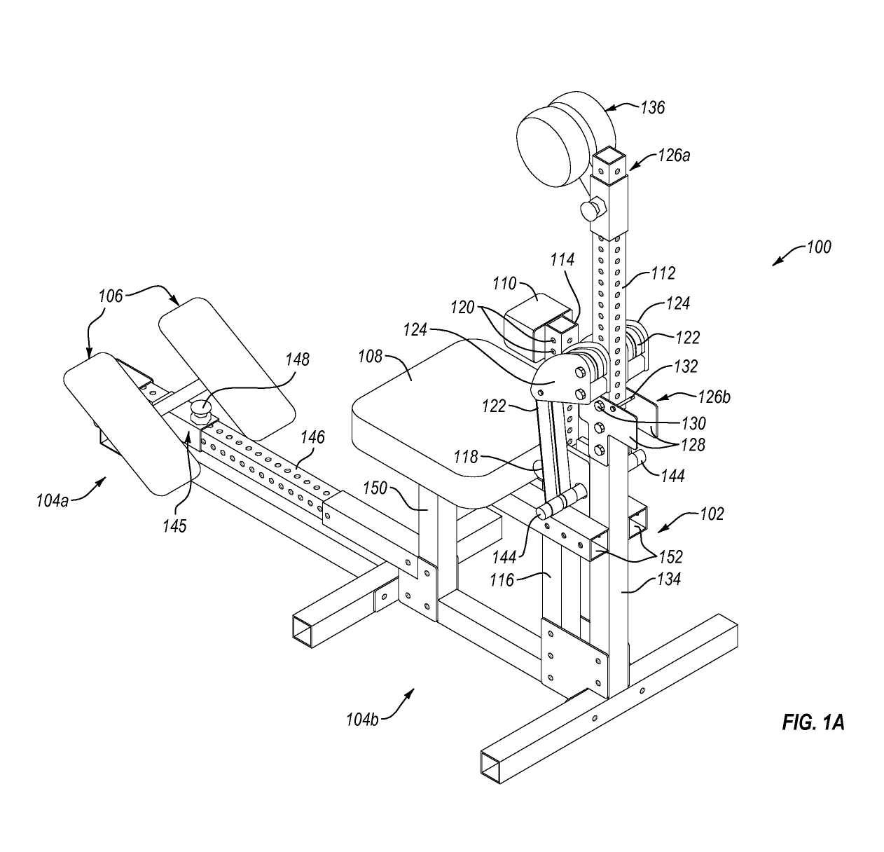

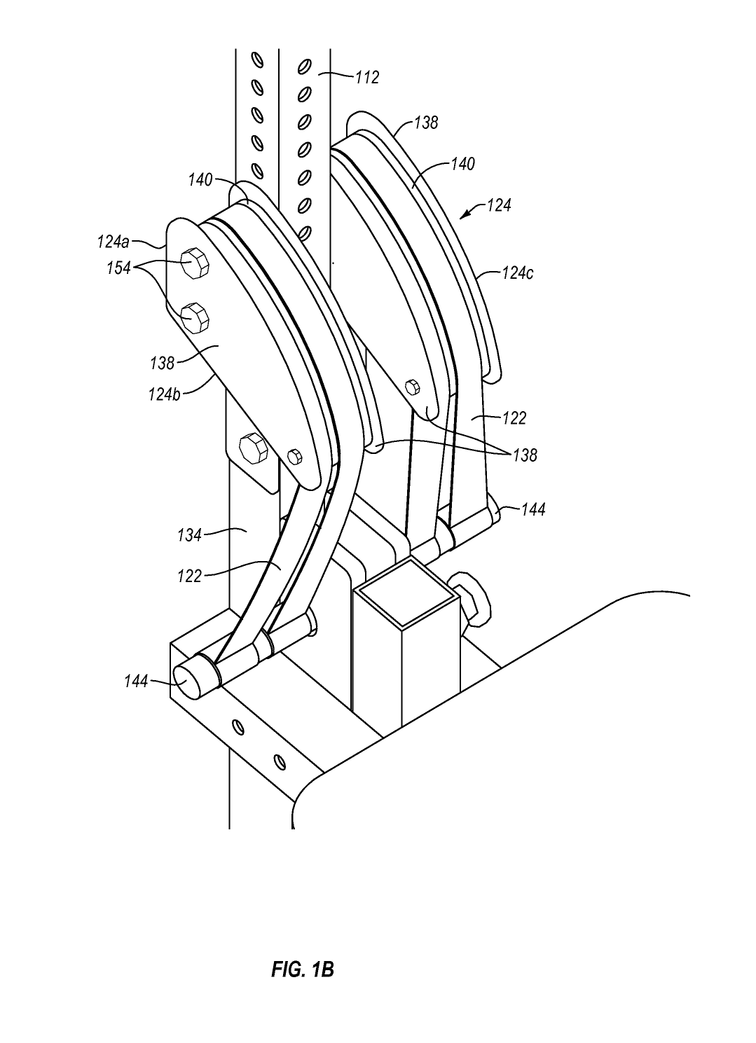

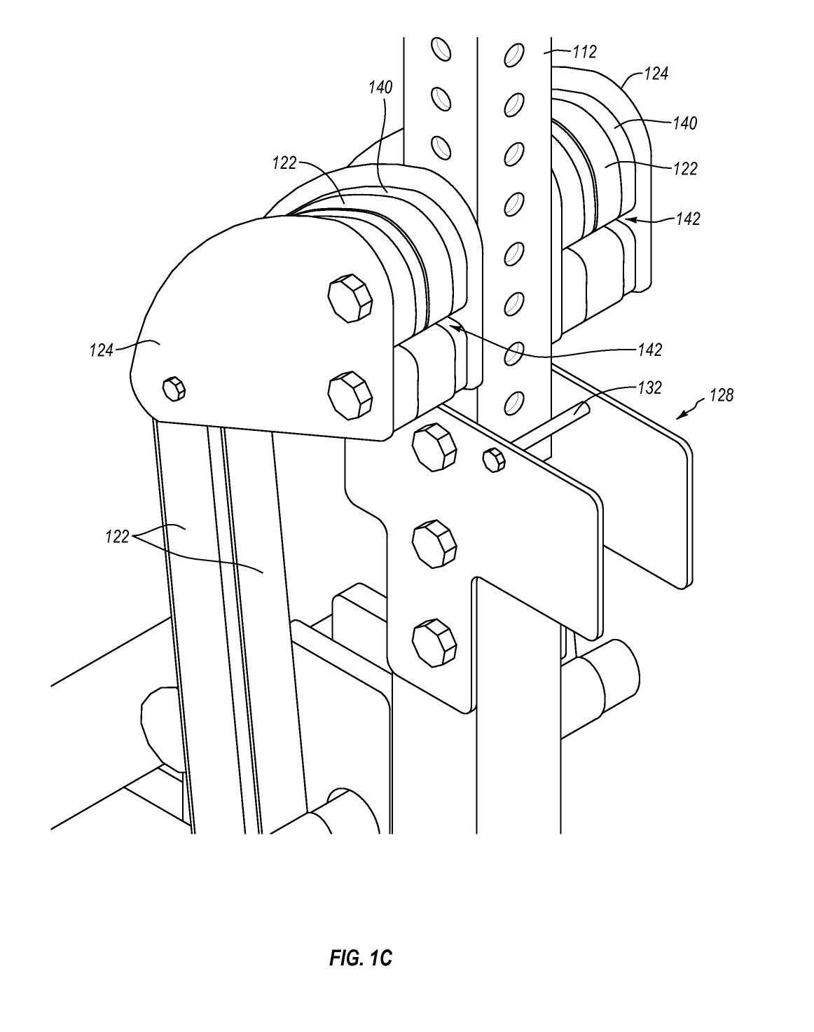

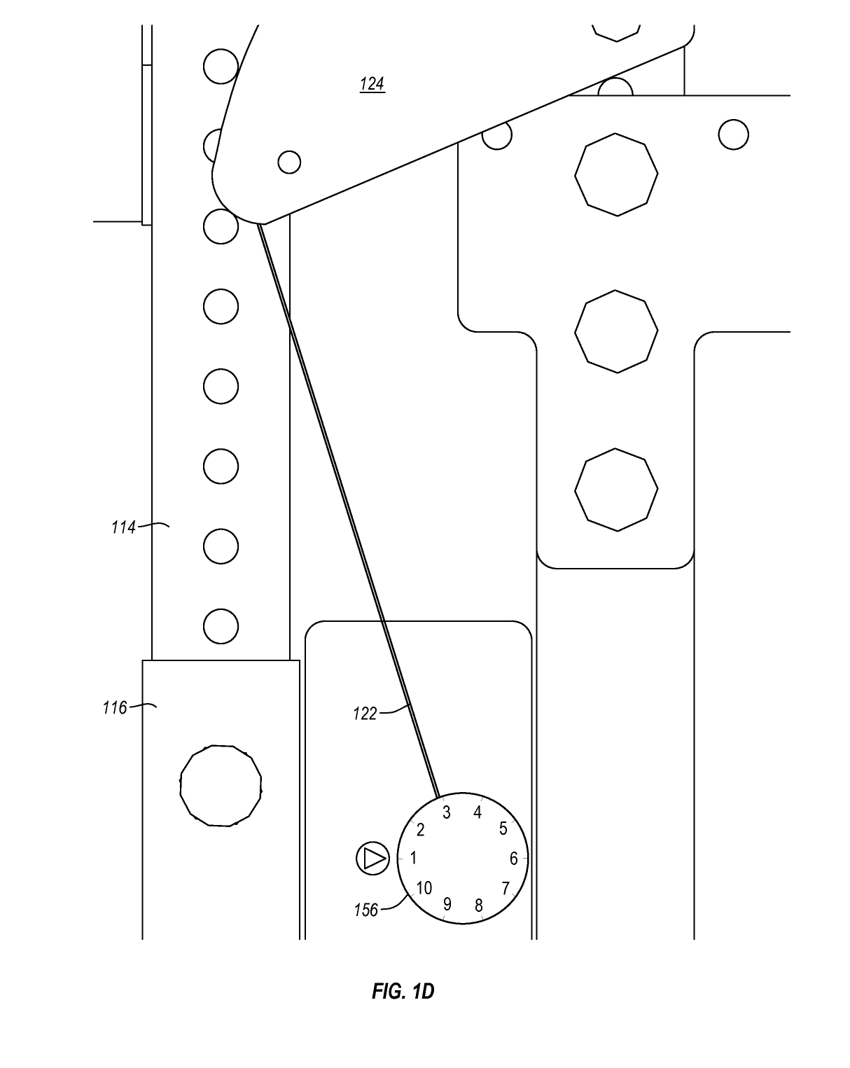

FIG. 1A shows an exemplary device 100 including a frame 102 extending between a foot end 104a and a head end 104b. Device 100 further includes a foot rest member 106 attached to the foot end 104a of frame 102. Illustrated foot rest member 106 includes two foot platforms, although it will be understood that alternative configurations (e.g., a single continuous platform sufficiently wide to accommodate both feet) may be provided. Foot rest member 106 may advantageously provide a fixed angle of about 30° relative to the floor and to horizontal seat member 108. Such a configuration advantageously places the user's knees at an angle of about 60° when seated upon horizontal seat member 108. In alternative embodiments, the angle of foot rest member 106 may be adjustable. The position of foot rest member 106 along frame 102 may be adjustable so as to accommodate varying leg lengths of different users. For example, foot rest member 106 may be attached to a sliding carriage 145 which slides along frame member 146. A coupling pin 148 may be provided to lock slidable carriage 145 into a desired position along frame member 146. Such a mechanism may easily allow for adjustment of the position of foot rest member 106 while the user is seated on seat member 108, while carriage 145 slides independent of the remainder of frame 102. Other mechanisms for adjusting a distance between foot rest member 106 and seat member 108 may alternatively be employed.

Device 100 further includes a seat member 108 attached to frame 102 between foot end 104a and head end 104b. Seat member 108 may be oriented so as to be generally horizontal relative to a floor surface on which frame 102 is placed. While some exercise devices seek to place the seat member on an incline or decline, positioning of seat member 108 so as to be generally horizontal aids in positioning the user's body and back in the desired orientation for the therapeutic exercise. In the illustrated embodiment, frame 102 supports seat member 108 with a generally vertical seat support member 150 positioned below a forward end of seat member 108. A pair of generally horizontal underseat frame members 152 may be provided below seat member 108 to either side of vertical support member 150. In addition to attachment to vertical support member 150, underseat frame members 152 may also be attached to back pad fulcrum support member 116 and pivoting post support member 134, which are aligned and parallel with seat support member 150. While other configurations for supporting seat member 108 are possible, the illustrated configuration provides excellent support, even for relatively heavy users. While it may be possible to support seat member 108 with an angled support member cantilevered out from one end of set member 108 towards an opposite end, such angled support member configurations may be susceptible to failure of welds or other joints due to repeated use by heavy users.

Near to and close behind seat member 108, a back pad fulcrum 110 is attached to frame 102, so as to be between seat member 108 and pivoting post 112. The contact planes (against which the user rests) defined by seat member 108 and back pad fulcrum 110 may be generally perpendicular to one another (i.e., seat member defines a generally horizontal plane, while back pad fulcrum 110 defines a generally vertical plane).

Back pad fulcrum 110 may have a relatively narrow left-right width so as to not provide any significant contact to the hips or waist of a user, but so as to provide only a small region of contact that is limited to the lumbar region of the vertebral column. For example, in an embodiment, a width of back pad fulcrum 110 may be limited to no more than about one half (50%), one-third (33%), or one-quarter (25%) of the width of seat member 108. The height of back pad fulcrum may similarly be limited. For example, the height of back pad fulcrum 110 may be no more than about the width of back pad fulcrum 110. In an embodiment, back pad fulcrum 110 may have a width from about 3 inches to about 8 inches, or from about 3 inches to about 6 inches.

Back pad fulcrum 110 may be attached at or near a top end of a generally vertical post 114 that may be slidably received within a generally vertical back pad fulcrum support member 116 of frame 102. The position above seat member 108 of back pad fulcrum 110 may be selectively adjustable by raising or lowering post 114 within fulcrum support member 116. For example, fulcrum support member 116 may include one or more through holes (not shown) through which a locking pin 118 may be disposed. Post 114 may include a series of holes 120, one of which may be aligned with the hole(s) of support member 116, and locking pin 118 may be inserted through the aligned hole(s) of post 114 and support member 116. In order to fix back pad fulcrum at a higher or lower height, the user releases locking pin 118 (e.g., by pulling it out of post 114), and adjusts slidable post 114 up or down as desired, and then reinserts pin 118 to lock back pad fulcrum 110 at a new desired height. Sliding carriage 145, for adjusting distance of the foot rest member 106 from seat member 108, and a similar sliding carriage 137 for adjusting the position of back roller 136 along pivoting post 112, may operate in a similar manner. Back pad 110 may remain in place independent of the position of pivoting post 112 (i.e., back pad 110 may not pivot with pivoting post 112).

When performing the repetitive exercise, one may begin with back pad fulcrum 110 at a relatively low setting, only somewhat above seat member 108, and perform several repetitions. For example, the level of back pad fulcrum 110 may initially be set so as to correspond to the bottom of the user's lumbar level. Once a desired number of repetitions have been achieved, the user may move back pad fulcrum 110 up an increment or two, and then repeat the exercise at the higher position. As fulcrum 110 is progressively moved upward, the fulcrum may be at heights corresponding to the user's thoracic level. Because the user's back is pressed firmly backwards against back pad fulcrum 110 during use, at least the rearward bending motion of the user's torso is largely focused on that portion of the back that is above the back pad fulcrum, allowing the user to progressively stimulate different segments of the vertebrae.

As described above, no trained clinical oversight during use of the device is typically required, and the user's spine is typically not rigidly fixated within the device. Rather, minimal user education (e.g., provided through a user manual or demonstration) is sufficient to enable a user to use the device with little or no risk of injury in an unsupervised regimen. The device provides a safe foundation upon which to permit general spinal extension, but does not forcefully fix the user's body within the device. Thus, no seat belts or other fixation structures are typically provided. The device rather places the user on the seat member 108, with the back against back pad fulcrum 110, and allows the user to target exercise of all spinal regions more or less simultaneously. The user may further target exercise to a shorter length of the spine by increasing the height of the back pad fulcrum. The exercises are configured to achieve results through relatively lower resistance, higher frequency (e.g., more than twice a week) and higher repetition (e.g., 10 or more reps at a time) than devices, such as the PneuBack Chair, which rely on user fixation and forceful protocols that deliver higher resistance and require lower frequency and lower repetition (under clinical supervision) to achieve a desired result while managing injury risk.

The device includes a pivoting post 112 attached to head end 104b of frame 102. Pivoting post 112 is aligned with (i.e., in the same central longitudinal plane running from the head end to the foot end of device 100), but disposed behind and above back pad fulcrum 110. Pivoting post 112, in conjunction with one or more resistance members 122 and cam structures 124 associated with pivoting post 112, provides resistance to the repetitive forward and backward torso movement that provides cyclic loading, hydration and stimulation of the vertebral segments while strengthening the para-spinal muscles. For example, such exercise can favor increased bone density, muscle conditioning, and disc hydration.

Pivoting post 112 may extend from a top end 126a to a bottom end 126b. Top end 126a may be free, while bottom end 126b may be pivotally coupled between opposing plates of bracket 128 with a pivot pin 130. Bracket 128 may include forward and rear stops 132 to limit pivoting arc length of pivoting post 112. Bracket 128 may be attached to a generally vertical pivoting post support member 134 of frame 102. Support member 134 may be generally parallel to and directly behind back pad fulcrum support member 116.

Pivoting post 112 may include a back roller 136 or a back pad for making contact with the user's back and/or neck during use. Roller 136 may alternatingly roll up and down over the central portion of the user's back and/or neck surrounding the spine so as to create a massaging action that encourages continued use. As described above, carriage 137 may be slidable along pivoting post 112 to allow a user to set back roller 136 at the desired height. Although illustrated with a roller 136, it will be understood that a sliding pad may alternatively be provided, that may slide up and down (rather than roll up and down) the user's back and/or neck.

Because the pivot point 130 is positioned behind the user's hip's axis, a longer distance along the user's back and neck may be massaged than if the pivot point were closer to the user's hips (e.g., were the pivot point vertically aligned with support member 116 rather than support member 134, which is behind support member 116). In one embodiment, the distance between pivot point 130 and back pad fulcrum 110 (which may be related to the position of the axis of the user's hips) may be from about 4 inches to about 16 inches, from about 5 inches to about 12 inches, or from about 6 inches to about 10 inches.

FIGS. 1B-1C shows close up views of cam structures 124 attached to pivoting post 112 (e.g., through one or more bolts 154), as well as some of the surrounding components. Back pad fulcrum 110 and associated support member 114, as well as bracket 128, have been removed so as to better show cams 124. Cams 124 may be disposed on opposite (e.g., right and left) sides of pivoting post 112. Cams 124 may be generally tear drop or generally triangular in shape. For example, if the shape is generally triangular, the hypotenuse 124c of the triangle may be curved, as shown, while the adjacent legs 124a, 124b of the triangle may be generally straight. Each cam 124 may include opposed outer plates 138 and a curved surface 140 disposed therebetween such that curved surface 140 extends so as to be generally aligned with the top surface 124c “hypotenuse” curve of cam 124. It will of course be understood that in some embodiments, outer plates 138 may be differently curved or shaped than curved surface 140 (e.g., plates 138 could simply be rectangular, while surface 140 was curved as seen in FIGS. 1A-1C). Curvature of surface 140 provides a race within which resistance members 122 may be seated, against surface 140 and between plates 138, which extend beyond surface 140, to better retain resistance members 122 in place.

Resistance members 122 may comprise elastomeric bands (e.g., bungee cords or bands), in which an end of each band 122 may be attached to cam 124. For example, in the illustrated embodiment, curved surface 140 may extend partially along cam leg 124a, and a recess 142 may be provided where elastomeric bands 122 wrap around an end of curved surface 140, and are attached to cam 124 in recess 142. Other attachment mechanisms may alternatively be employed. Thus, in the illustrated embodiment, resistance members 122 may wrap around an end of curved surface 140 at leg 124a, and then follow curve 140 (e.g., in a curve resembling a longitudinal half a heart shape) to the intersection of curved surface 140 and leg 124b. At this end of cam 124, elastomeric bands 122 may extend to a point of attachment to frame 102. For example, in the illustrated embodiment, an end of elastomeric members 122 may be attached to attachment posts 144 that may extend laterally (e.g., left and right) out from frame 102. For example, a coupling ring may be sewn or otherwise attached to elastomeric member 122 to allow the coupling ring to be placed over post 144. Various other attachment mechanisms may be employed for attaching one end of elastomeric members 122 to cam 124, while an opposite end is attached to a portion of frame 102 that may not pivot with pivot post 112.

In the illustrated embodiment, the point of attachment of resistance member 122 to frame (e.g., at post 144) may be approximately at or above the height of the seat level, making it easier for a user to engage or disengage one or more resistance members, as needed (e.g., as compared to an embodiment where the attachment point may be at or near the floor).

A user may adjust the resistance provided by elastomeric members 122 by simply increasing or decreasing the number of elastomeric members wound about each cam 124, or by replacing one or more resistance members 122 with resistance members having a greater or lesser level of stiffness. More stiff elastomeric members would provide greater levels of resistance. In one embodiment, elongate flat bungee elastomeric members may be employed. For example, such a bungee may be about 0.75 inch in width, while cams 124 may include a curved surface width of about 1.5 to about 2 inches, so as to accommodate the width of two such bungees. Each bungee may provide a resistance of about 2 pounds (e.g., where 2 bungees are provided on each cam, about 8 pounds of resistance would be provided). One may decrease the amount of resistance by merely disengaging one or more of the bungees from attachment posts 144.

In another embodiment, it may be desirable that both ends of the resistance member be more or less permanently attached to device 100, so that the user is not required to disengage and/or re-engage a bungee, spring, or other resistance member. Such a configuration may be desirable for safety reasons. In such an embodiment, it would be advantageous to provide a mechanism for adjusting resistance without requiring the user to disengage or engage the resistance members. One such configuration is shown in FIG. 1D, in which a tensioning knob 156 or similar device is provided about which an elastomeric member 122 may be wrapped so as to increase or decrease its effective length. As the effective length is decreased, the tension (and thus resistance) provided by the elastomeric member 122 increases. Similarly, as one unwinds elastomeric member 122 from about tensioning knob 156, the effective length of member 122 increases, decreasing the resistance provided by member 122.

Any of various tensioning devices as known in the art may be employed. For example, any of the configurations described in U.S. Pat. Nos. 5,934,599, 6,209,953, 6,289,558, 7,591,050, 7,950,112, 7,992,261, 7,954,204, or 8,091,182, to Boa Technology, Inc. may be employed. Each of the above U.S. patents is herein incorporated by reference in its entirety. Other configurations that allow one to wind or unwind an elastomeric member about a tensioning knob may alternatively be employed.

In one embodiment, tensioning knob 156 may include indicia thereon indicating to the user the level of resistance (or a relative level of resistance such as a value between 1 and 10) provided by a given knob position. One may simply turn the knob so as to increase or decrease the level of resistance provided, as desired.

As will be readily apparent from the Figures, many of the components of the device (e.g., back pad 110, pivoting post 112, seat 108, roller 136, etc.) employed in the exercise are axially aligned with one another, positioned along a central longitudinal plane of the device. Many of the other components (e.g., individual foot platforms of foot rest member 106, cams 126) present, particularly those present in pairs or other multiples, may be disposed symmetrically, on either side of the central longitudinal plane of device 100.

As shown in the Figures, in an embodiment, opposed left and right lateral sides of the device are not blocked by structures of the device (e.g., extension arms, etc.) that may otherwise impede the ability of a user to easily enter or exit the device from either the left or right side, as desired. For example, where an extension arm were provided on either the left or right side that would impede user access on the side where the extension arm is present, placement of the device cannot be conveniently achieved adjacent a wall that would impede access from the other side. Where both the right and left sides of the seat member are easily accessible and not so blocked, the user may easily enter or exit from either lateral side, as desired.

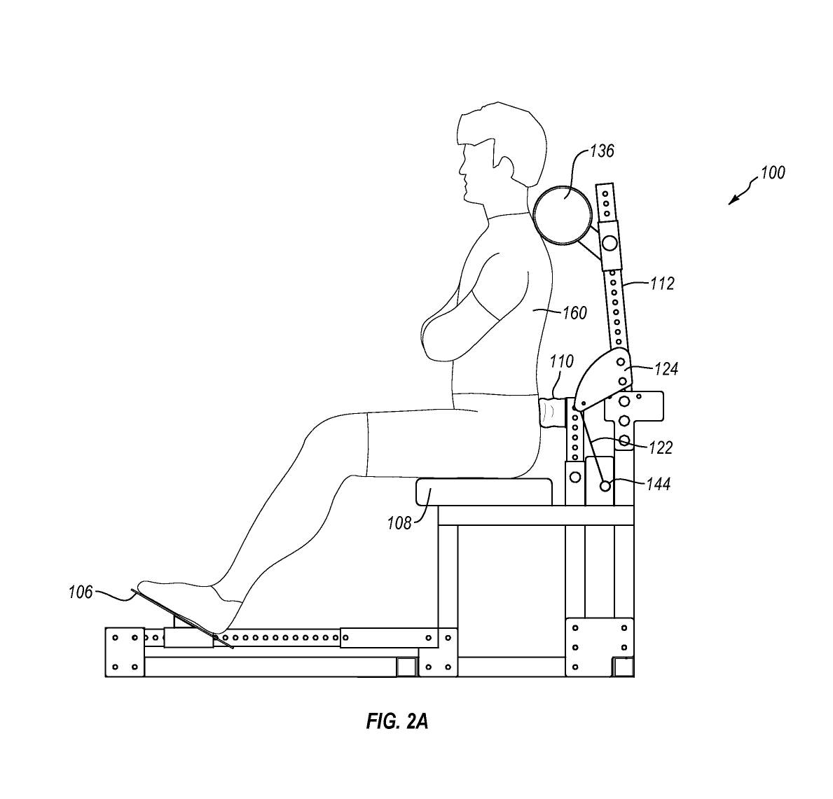

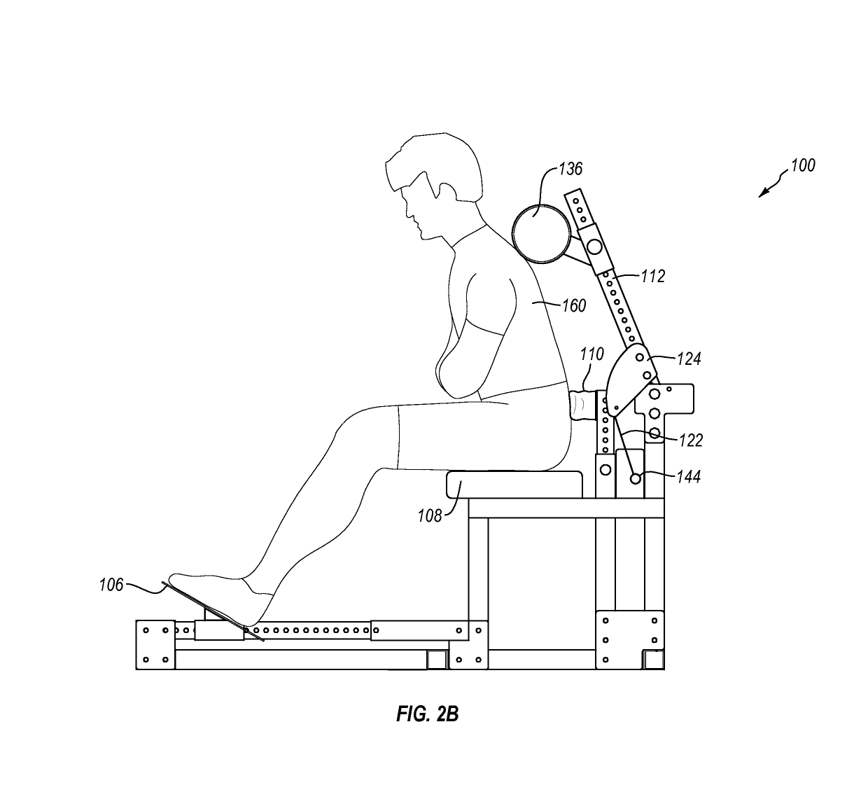

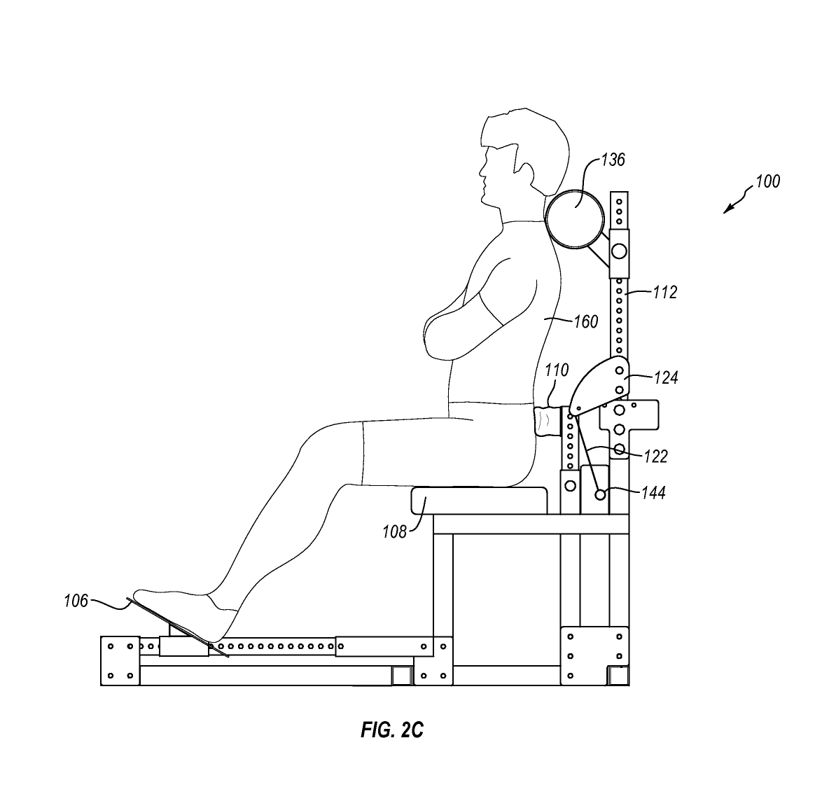

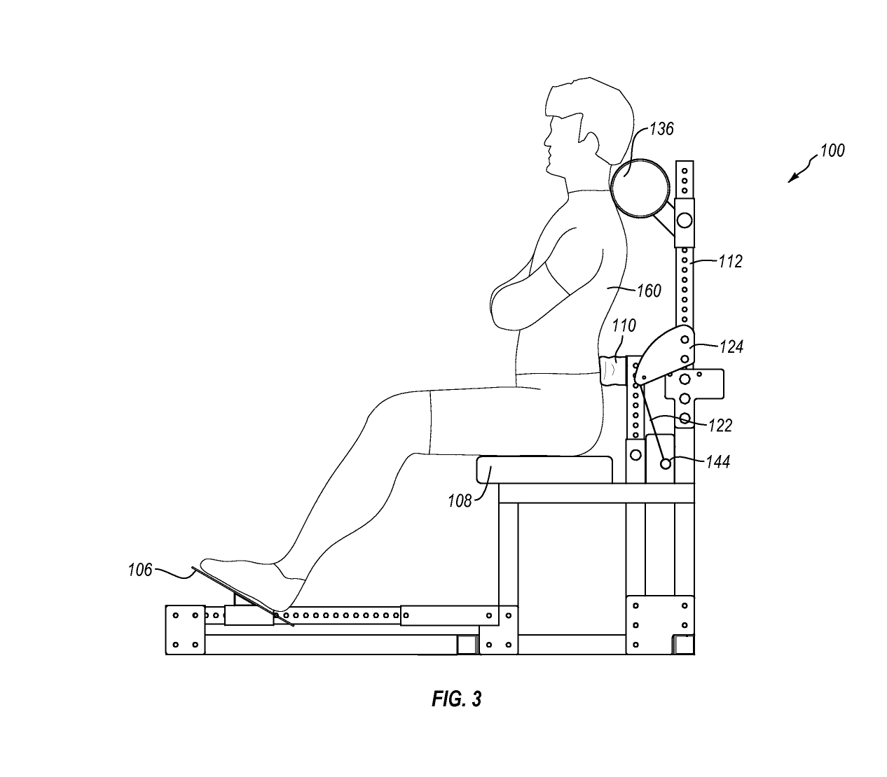

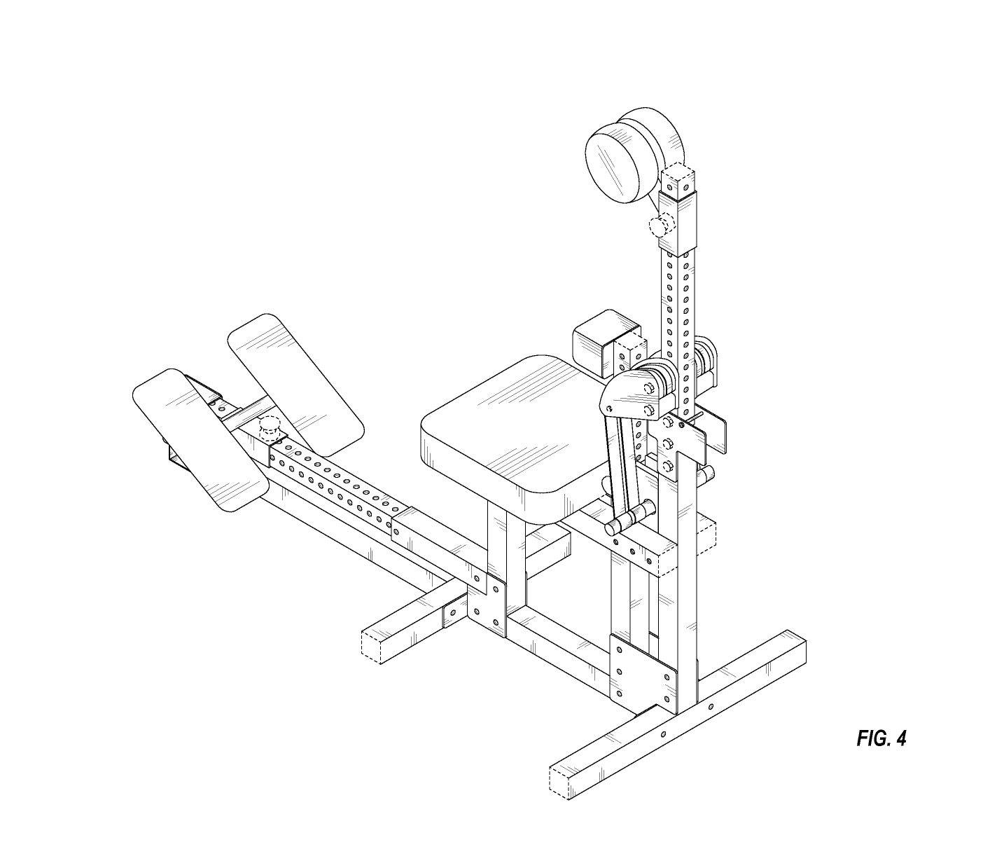

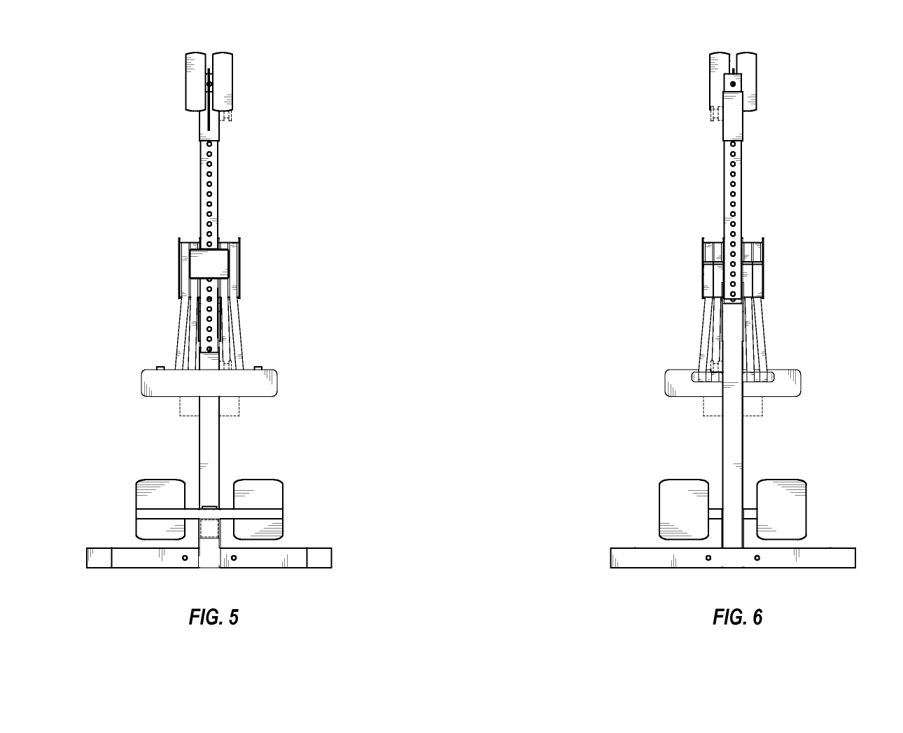

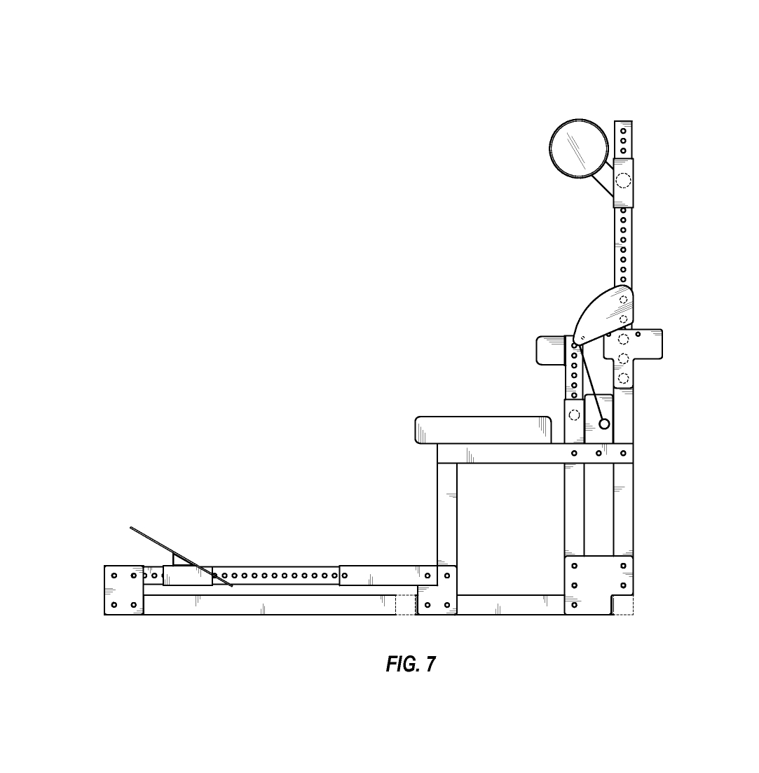

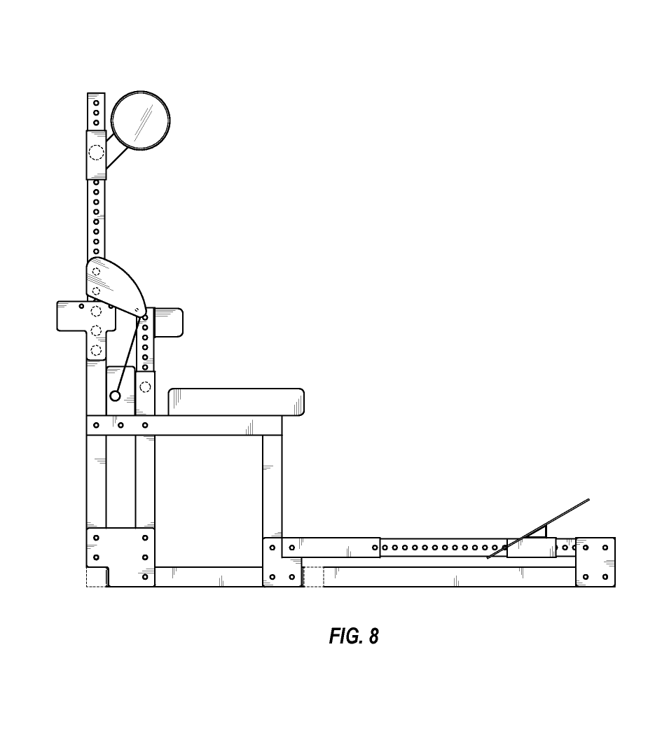

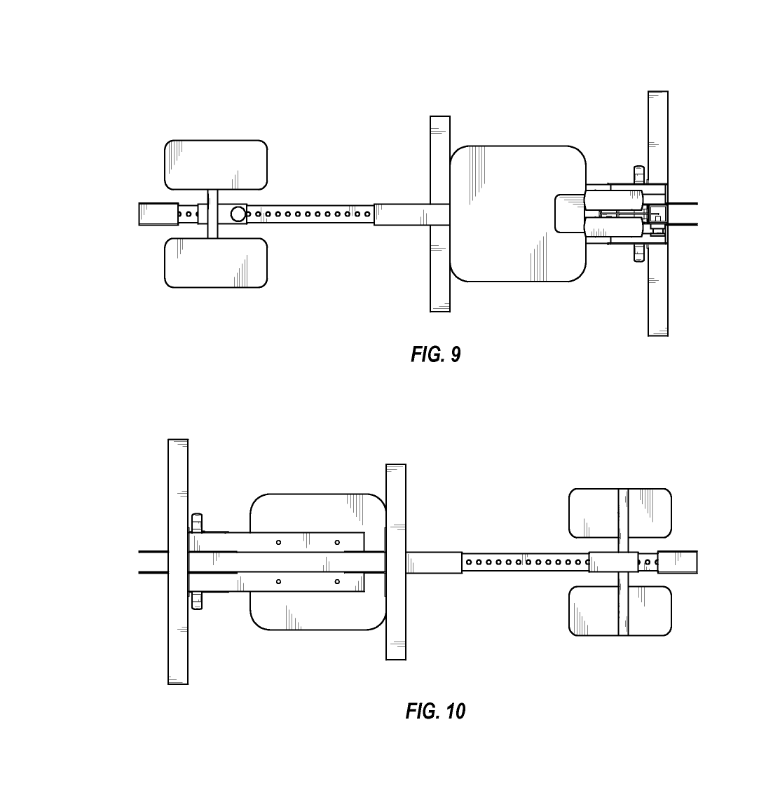

FIGS. 2A-2C and FIG. 3 show exemplary use of the device. For example, as seen in FIG. 2A, the user may be ready to begin, where the torso of user 160 is in a generally upright position. In FIG. 2B, the user's torso has been bent forwards, causing back roller 136 to roll over the back of user 160, as pivoting post 112 is biased to an acute angle relative to seat 108. For the backwards stroke, as shown in FIG. 2C, user 160 presses roller 136 (and pivoting post 112) rearwardly, extending the spine while employing that portion of the back that is above back pad fulcrum 110 to achieve the desired rearward movement of pivoting post 112, which is achieved under resistance provided by resistance members 122. Once a desired number of repetitions have been performed (e.g., 10) by alternatingly bending the torso rearward (the resistance stroke) and forward, the user may pull pin 118, and move back pad fulcrum 110 up (e.g., 1-2 positions), and repeat the exercise. At the end of the next set of repetitions, the back pad fulcrum may again be raised, until a desired lumbar level of the back pad fulcrum is achieved. By way of example, the inventors have found that even a 5-10 minute exercise protocol based on the exercises described above is often sufficient to relieve back or similar pain (e.g., if one were experiencing back or sciatic pain, 5-10 minutes of exercise may result in dramatically reduced pain or complete elimination of the pain). Alternative methods of use may similarly be employed. For example, one could begin with back pad fulcrum 110 at an elevated position, and work downwards.

In an embodiment, the frame of the device may be foldable so as to allow for relatively compact storage of a unit intended for use in the home or other environment where space may be at a premium.

As used in this specification and the appended claims, the singular forms “a,” “an” and “the” include plural referents unless the context clearly dictates otherwise.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device for repetitive spine extension at selectable lumbar levels, the device comprising:
a frame extending between a foot end and a head end;
a foot rest member attached to the foot end of the frame;
a horizontal seat member attached to the frame between the foot end and the head end of the frame;
a back pad fulcrum attached to the frame between the seat member and the pivoting post, the back pad fulcrum being adjustable in height above the seat member to allow progressive repetitive spinal extension at varied lumbar levels; and
a pivoting post attached to the head end of the frame, positioned behind the back pad fulcrum, so that a user seated on the seat member may press the pivoting post backwards as the user rearwardly extends an upper portion of a torso of a user as the lower portion of a back of a user is pressed against the back pad fulcrum; and
at least one cam on a side of the pivoting post to which one or more resistance members are attached, one end of each resistance member being attached to a corresponding cam while an opposite end of each resistance member is attached to the frame at a location below the pivoting post so that as the cam(s) pivot with the pivoting post, resistance is provided as the post is pivoted backwards as the user's back above the back pad fulcrum presses the pivoting post backwards;
wherein the frame includes a generally vertical pivoting post support member and a generally vertical back pad fulcrum support member that is parallel to and in front of the pivoting post support member so that when the pivoting post is vertical it defines a vertical axis that is behind a generally vertical axis of the back pad fulcrum support member.

2. A device as recited in claim 1, wherein the footrest member is selectively slidable along the foot end of the frame to allow a distance between the footrest member and the seat member to be selectively adjusted.

3. A device as recited in claim 1, wherein the seat member is supported by the frame, that portion of the frame supporting the seat member comprising a generally vertical seat support member attached below a forward end of the seat member and a pair of generally horizontal underseat frame members attached below the seat member on either side of the vertical seat support member.

4. A device as recited in claim 1, wherein the back pad fulcrum is attached to a top end of a generally vertical post that is slidably received within the generally vertical back pad fulcrum support member of the frame, the back pad fulcrum support member being disposed between the seat member and the pivoting post.

5. A device as recited in claim 1, wherein the back pad fulcrum has a width that is no more than half a width of the seat member so that the back pad fulcrum does not provide any significant contact to hips of a user seated on the seat member.

6. A device as recited in claim 1, wherein opposed right and left lateral sides of the seat member are not blocked by structures of the device so as to facilitate easy accessibility of a user to the seat member from both the left and right lateral sides of the device.

7. A device as recited in claim 1, wherein each cam is disposed immediately adjacent a side of the pivoting post.

8. A device as recited in claim 1, wherein each cam comprises a generally triangular or tear-drop profile and includes a curved surface aligned with a top surface of the cam about which the resistance members extend.

9. A device as recited in claim 1, wherein the foot rest member provides a platform for the user's feet a fixed angle relative to the horizontal seat member, the fixed angle of the foot rest member platform(s) being about 30°.

10. A device as recited in claim 1, wherein the resistance members comprise elastomeric members.

11. A device for repetitive spine extension at selectable lumbar levels, the device comprising:
a frame extending between a foot end and a head end;
a foot rest member attached to the foot end of the frame;
a horizontal seat member attached to the frame between the foot end and the head end of the frame;
a back pad fulcrum attached to the frame between the seat member and the pivoting post, the back pad fulcrum being adjustable in height above the seat member to allow progressive repetitive spinal extension at varied lumbar levels; and
a pivoting post attached to the head end of the frame, positioned behind the back pad fulcrum, the pivoting post including a back roller or pad attached near a top free end of the pivoting post so that a user seated on the seat member may press the roller or pad and pivoting post backwards as a user rearwardly extends an upper portion of a torso of a user as a lower portion of a back of the user is pressed against the back pad fulcrum, the pivoting post being biased to default to an acute angle relative to the seat member; and
dual cams on either immediate side of the pivoting post about which one or more elastomeric resistance members extend, one end of each resistance member being attached to a corresponding cam and extending over a curved surface of each cam, the other end of each resistance member being attached to the frame at a location below the pivoting post so that the cams pivot with the pivoting post, providing resistance as the post is pivoted backwards as a user's back above the back pad fulcrum presses on the roller or pad.

12. A device as recited in claim 11, wherein the frame includes a generally vertical pivoting post support member and a generally vertical back pad fulcrum support member that is parallel to and in front of the pivoting post support member so that when the pivoting post is vertical it defines a vertical axis that is behind a generally vertical axis of the back pad fulcrum support member.

13. A device as recited in claim 11, wherein the seat member is supported by the frame, that portion of the frame supporting the seat member comprising a generally vertical seat support member attached below the forward end of the seat member, and a pair of generally horizontal underseat frame members attached below the seat member on either side of the vertical seat support member.

14. A device as recited in claim 11, wherein the back pad fulcrum is attached to a top end of a generally vertical post that is slidably received within a generally vertical back pad fulcrum support member of the frame, the back pad fulcrum support member being disposed between the seat member and the pivoting post.

15. A device as recited in claim 11, wherein the back pad fulcrum has a width that is no more than half a width of the seat member so that the back pad fulcrum does not provide any significant contact to hips of a user seated on the seat member.

16. A device as recited in claim 11, wherein opposed right and left lateral sides of the seat member are not blocked by structures of the device so as to facilitate easy accessibility of a user to the seat member from both the left and right lateral sides of the device.

17. A method for cyclic loading and stimulation of vertebral segments of a user, the method comprising:
providing a device as recited in claim 1;
sitting on the seat member with a lower lumbar back region of a user pressed against the back pad fulcrum; and
repetitively extending a torso of a user rearwardly and then forwardly so as to move the pivoting post backwards and forwards.

18. A method as recited in claim 17, wherein the method results in cyclic loading, hydration, and stimulation to vertebral segments of the user while strengthening and conditioning the para-spinal muscles.

19. A method for cyclic loading, and stimulation of vertebral segments of a user, the method comprising:
providing a device as recited in claim 11;
sitting on the seat member with a lower lumbar back region of a user pressed against the back pad fulcrum; and
repetitively extending a torso of a user rearwardly and forwardly so as to move the pivoting post backwards and forwards.
